(19) United States
(12) Patent Application Publication
(10) Pub. No.: US 2018/0350046 A1
(43) Pub. Date: Dec. 6, 2018

(54) IMAGE PROCESSING APPARATUS ADJUSTING SKIN COLOR OF PERSON, IMAGE PROCESSING METHOD, AND STORAGE MEDIUM

(71) Applicant: CASIO COMPUTER CO., LTD., Tokyo (JP)

(72) Inventors: Kyosuke SASAKI, Tokyo (JP); Takeharu TAKEUCHI, Tokyo (JP); Takao NAKAI, Tokyo (JP); Daiki YAMAZAKI, Tokyo (JP)

(73) Assignee: CASIO COMPUTER CO., LTD., Tokyo (JP)

(21) Appl. No.: 15/996,932

(22) Filed: Jun. 4, 2018

(30) Foreign Application Priority Data
Jun. 6, 2017 (JP) 2017-111907

(51) Int. Cl. G06T 5/00; G06T 7/90

(52) U.S. Cl. CPC G06T 5/008; G06T 2207/30088; G06T 2207/30201; G06T 7/90

(57) ABSTRACT

An image processing apparatus includes a processor which is an image processing processor that is configured to: perform beautiful skin processing, which is processing of beautifying a skin color, on a person portion included in an image, specify a first portion which is a skin color and is a non-makeup portion, and a second portion which is a skin color and a makeup portion, in the person portion of the image, acquire first skin color information which is information corresponding to the skin color of the specified first portion, and second skin color information which is information corresponding to the skin color of the specified second portion, and adjust the beautiful skin processing, on the basis of the acquired first skin color information and the acquired second skin color information.

This application is based on and claims the benefit of priority from Japanese Patent Application No. 2017-111907, filed on Jun. 6, 2017, the content of which is incorporated herein by reference.

### BACKGROUND OF THE INVENTION

### Field of the Invention

The present invention relates to an image processing apparatus, an image processing method, and a storage medium.

### Related Art

In the related art, a technology of adjusting a skin color of a face, which is referred to as whitening processing of applying processing of whitening a skin color of a face of a person included in an image, is known. For example, a technology in which a highlighted portion becomes brighter without losing a stereoscopic effect, is also disclosed in JP 2006-121416 A.

However, in a case where a person included in the image wears makeup, there is a case where a skin color is not capable of being suitably adjusted, according to the presence or absence of the makeup such as an intensity or a color of the makeup.

The present invention has been made in consideration of the circumstance described above, and an object thereof is to suitably adjust a skin color of a face of a person in consideration of the presence or absence of a makeup.

### SUMMARY OF THE INVENTION

According to an aspect of the present invention, an image processing apparatus includes a processor which is an image processing processor that is configured to:

perform beautiful skin processing, which is processing of beautifying a skin color, on a person portion included in an image;

specify a first portion which is a skin color and is a non-makeup portion, and a second portion which is a skin color and a makeup portion, in the person portion of the image;

acquire first skin color information which is information corresponding to the skin color of the specified first portion, and second skin color information which is information corresponding to the skin color of the specified second portion; and

adjust the beautiful skin processing, on the basis of the acquired first skin color information and the acquired second skin color information.

According to another aspect of the present invention, an image processing apparatus includes:

a processor which is an image processing processor that is configured to:

detect a skin color portion in a face portion of a person included in an image;

acquire a dispersion situation of skin color information of the detected skin color portion; and

perform processing of adjusting a skin color in the face portion of the person included in the image, on the basis of the acquired dispersion situation of the skin color information.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

More detailed understanding of the present application can be obtained by considering the following detailed description together with the following drawings.

FIG. 1 is a block diagram illustrating a hardware configuration of an image capture apparatus according to one embodiment of an image processing apparatus of the present invention.

FIG. 2 is a schematic view for illustrating adjustment of makeup processing in the present embodiment.

FIG. 3 is a schematic view for illustrating a makeup effect of a subject.

FIG. 4 is a functional block diagram illustrating a functional configuration for executing makeup adjustment processing, in a functional configuration of the image capture apparatus of FIG. 1.

FIG. 5 is a flowchart illustrating a flow of the makeup adjustment processing which is executed by the image capture apparatus of FIG. 1 having the functional configuration of FIG. 4.

FIG. 6 is a flowchart illustrating a flow of skin color difference acquisition processing.

FIG. 7 is a flowchart illustrating a flow of skin color uniformity acquisition processing.

FIG. 8 is a schematic view for illustrating the contents of correction processing of adding correction contents desired by a user and an intensity thereof, in addition to correction of the makeup adjustment processing.

### DETAILED DESCRIPTION OF THE INVENTION

Embodiments of the present invention will be explained with reference to the drawings.

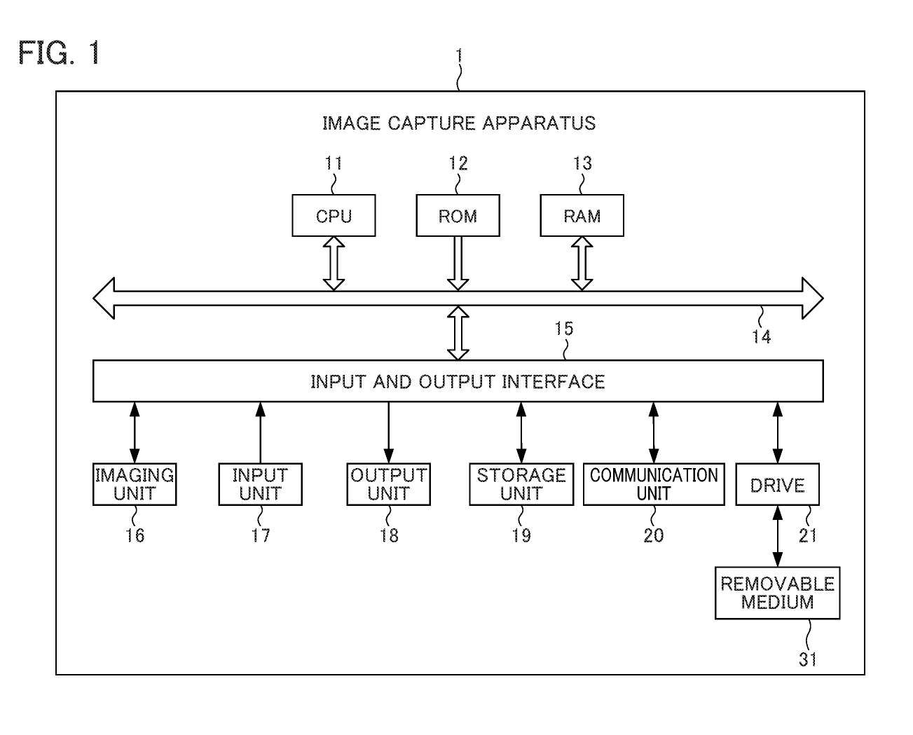

FIG. 1 is a block diagram showing the configuration of the hardware of the image capture apparatus 1. For example, the image capture apparatus 1 is a digital camera.

As shown in FIG. 1, the image capture apparatus 1 includes a processor (CPU) 11, a read only memory (ROM) 12, a random access memory (RAM) 13, a bus 14, an input-output interface 15, an image capture unit 16, an input unit 17, an output unit 18, a storage unit 19, a communication unit 20, and a drive 21.

The processor 11 executes various types of processing according to a program stored in the ROM 12 or a program loaded from the storage unit 19 into the RAM 13.

Data and the like required by the processor 11 executing the various processing is stored in the RAM 13 as appropriate.

The processor 11, the ROM 12, and the RAM 13 are connected to each other via the bus 14. In addition, the input-output interface 15 is also connected to this bus 14. The input-output interface 15 is further connected to the image capture unit 16, the input unit 17, the output unit 18, the storage unit 19, the communication unit 20, and the drive 21.

The image capture unit 16 includes an optical lens unit and an image sensor, which are not shown.

In order to photograph a subject, the optical lens unit is configured by a lens such as a focus lens and a zoom lens for condensing light. The focus lens is a lens for forming an image of a subject on the light receiving surface of the image sensor. The zoom lens is a lens that causes the focal length to freely change in a certain range. The image capture unit 16 also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is constituted by an optical sensor such as an optoelectronic conversion device of a CMOS (Complementary Metal Oxide Semiconductor) type. A subject image is incident upon the optoelectronic conversion device through the optical lens unit. The optoelectronic conversion device optoelectronically converts (i.e. captures) the image of the subject, accumulates the resultant image signal for a predetermined period of time, and sequentially supplies the image signal as an analog signal to the AFE. The AFE executes a variety of signal processing such as A/D (Analog/Digital) conversion processing of the analog signal. A digital signal is generated by various kinds of signal processing and is appropriately supplied as an output signal (RAW data or data in a predetermined image format) of the image capture unit 16 to the processor 11, an image processing unit (not shown), or the like.

The input unit 17 is constituted by various buttons, and the like, and inputs a variety of information in accordance with instruction operations by the user. The output unit 18 is constituted by a display, a speaker, and the like, and outputs images and sound. The storage unit 19 is constituted by DRAM (Dynamic Random Access Memory) or the like, and stores various kinds of data. The communication unit 20 controls communication with a different apparatus via the network 300 including the Internet.

A removable medium 31 composed of a magnetic disk, an optical disk, a magneto-optical disk, a semiconductor memory or the like is loaded in the drive 21, as necessary. Programs that are read via the drive 21 from the removable medium 31 are installed in the storage unit 19, as necessary. Like the storage unit 19, the removable medium 31 can also store a variety of data such as data of images stored in the storage unit 19.

In an image capture apparatus 1 of the present embodiment, a function of determining a makeup state of a subject such as a person, and of adjusting makeup processing (beautiful skin processing) of image processing according to the determined makeup state, is realized. That is, the image capture apparatus 1 calculates a difference between color information of a makeup portion (a portion of a face) and color information of a non-makeup portion (a portion of neck or ears) (hereinafter, referred to as a “skin color difference”), in a skin area of the subject (a skin color portion). In addition, the image capture apparatus 1 calculates a variation in a skin color in each position of a forehead, a cheek, or the like (hereinafter, referred to as a “skin color uniformity”), in the skin area of the subject. Then, the image capture apparatus 1 adjusts the skin color of the subject according to the skin color difference, and adjusts an intensity of adjusting the skin color of the subject according to the skin color uniformity. As a result thereof, it is possible to adjust the makeup processing of the image processing, according to the makeup state of the subject.

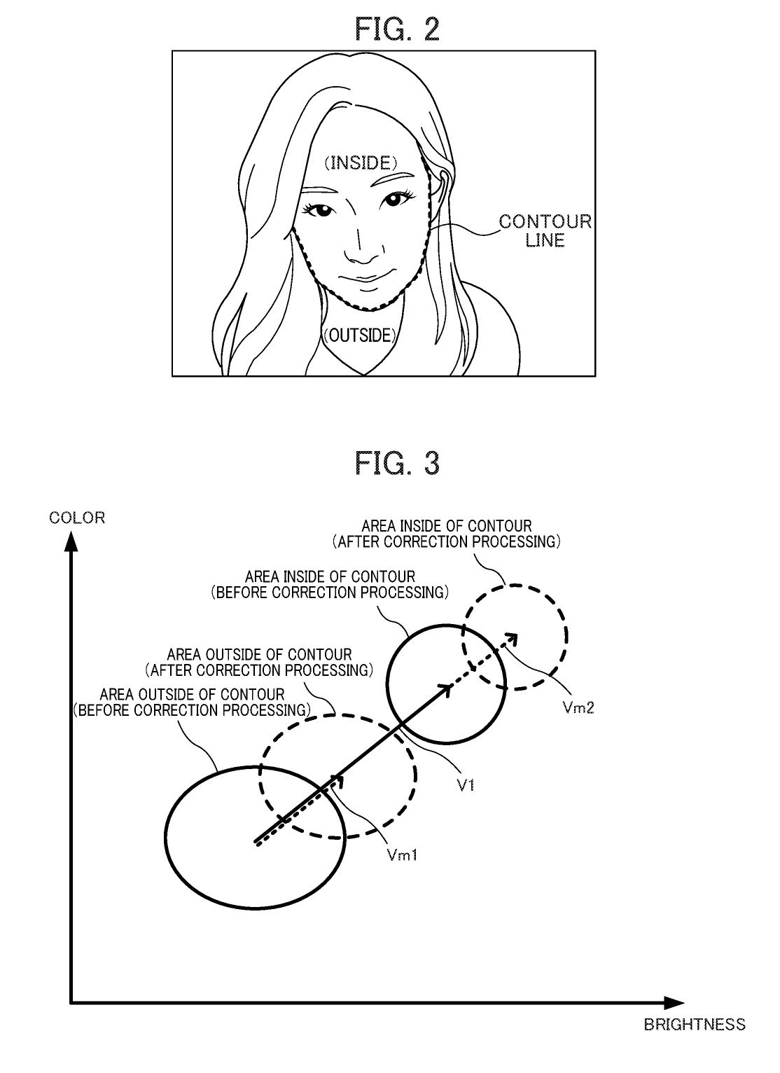

FIG. 2 is a schematic view for illustrating the adjustment of the makeup processing in the present embodiment. In a case where the makeup processing in the present embodiment is adjusted, as illustrated in FIG. 2, a contour of the face of the subject is detected in data of an image of the target to be subjected to the makeup processing. Then, in the skin color portion of the subject, color information on the inside of the detected contour (that is, the portion of the face), and color information on the outside of the detected contour (that is, the portion of the neck or the ears) are acquired. Further, a makeup effect of the subject is detected from a difference between the acquired color information on the inside of the contour (the portion of the face) and the acquired color information on the outside of the contour (the portion of the neck or the ears) (the skin color difference). The makeup effect is a parameter indicating a balance in correction of a color and a brightness with respect to the skin of the subject (a makeup tendency). In addition, in the skin color portion of the subject, a variation in the skin color (the skin color uniformity) in each of the positions (the forehead, the cheek, or the like) on the inside of the detected contour (that is, the portion of the face) is acquired. Then, an intensity of the makeup effect of the subject is detected from the acquired skin color uniformity. It is considered that in a case where the subject wears makeup, a variation in the skin color in each of the positions of the portion of the face is reduced, compared to a case of the skin. The intensity of the makeup effect is a parameter indicating an intensity of the correction of the color and the brightness with respect to the skin of the subject (a makeup heaviness).

FIG. 3 is a schematic view for illustrating the makeup effect of the subject. As illustrated in FIG. 3, in coordinates where a brightness of a pixel is represented on a horizontal axis, and a color of the pixel is represented on a vertical axis, an area outside of the contour (the portion of the neck or the ears) and an area of the inside of the contour (the portion of the face) are dispersed in the skin color portion of the subject, as a set of the pixels, respectively. That is, in FIG. 3, the color of the skin and a brightness area, and the color of the skin and a brightness area in a makeup state are specified. In addition, in the area the inside of the contour (the portion of the face) in FIG. 3, a variation in the skin color in each of the positions (the forehead, the cheek, or the like) (the skin color uniformity) is acquired. Then, in the area outside of the contour and the area inside of the contour, a distance and a direction between the areas are a parameter indicating the makeup effect of the subject (a vector V1 indicating a change in color or a brightness according to the makeup), and a magnitude of a variation in the skin color in the area inside of the contour (a dispersion situation of the color information) is a parameter indicating the intensity of the makeup effect.

In the example illustrated in FIG. 3, a direction from the area outside of the contour towards the area inside of the contour is a direction of correction of the area outside of the contour and the area inside of the contour. In addition, in the area outside of the contour and the area inside of the contour, and the correction is applied at intensities different from each other (in FIG. 3, correction vectors Vm1 and Vm2 illustrated by a broken line). For example, the area inside of the contour can be corrected by reducing the intensity of the correction (for example, at approximately 70 percent), with respect to the intensity of the correction of the area outside of the contour. Here, the same correction may be applied in the area outside of the contour, with respect to the intensity of the correction of the area inside of the contour.

In the present embodiment, such a makeup effect of the subject and the intensity thereof are detected, and the makeup processing based on the makeup effect of the subject and the intensity thereof can be applied with respect to the skin color portion not having a makeup. In addition, the makeup processing of enhancing or reducing the intensity can be applied with the same tendency as that of the makeup effect of the subject, and a makeup effect different from the actual makeup effect can be applied by changing a balance in the correction of the color of the skin and the brightness in the detected makeup effect of the subject. In addition, the makeup processing of enhancing or reducing the detected makeup effect can also be applied with respect to the skin color portion having a makeup. The user is capable of setting a mode of the makeup processing with respect to any processing.

Furthermore, the skin color portion in the subject can be specified by using a map in which the area of the skin color in the image of the subject is extracted (hereinafter, referred to a “skin map”). For example, in preparation of the skin map, first, the image of the subject represented by a YUV color space is converted into a HSV (Hue, Saturation (chroma), and Value (lightness, brightness)) color space. The HSV is measured from the image converted into the HSV color space, and an average value of each of H, S, and V channels is calculated. Then, a skin color level (Lh, Ls, and Lv) indicating a skin color likeness of the H, S, and V channels is calculated with respect to each of H, S, and V in the pixel, from a weighting determined in advance, according to a difference from the average value. After that, the skin color level of each of the calculated H, S, and V channels is multiplied, a skin map value in the pixel is calculated, and the skin map configured of the skin map value is prepared. In the skin map, a skin color-like portion and a non-skin color-like portion are gradually displayed. In the skin map of this example, for example, a white color is displayed as the most skin color-like portion, and a black color is displayed as the most non-skin color-like portion.

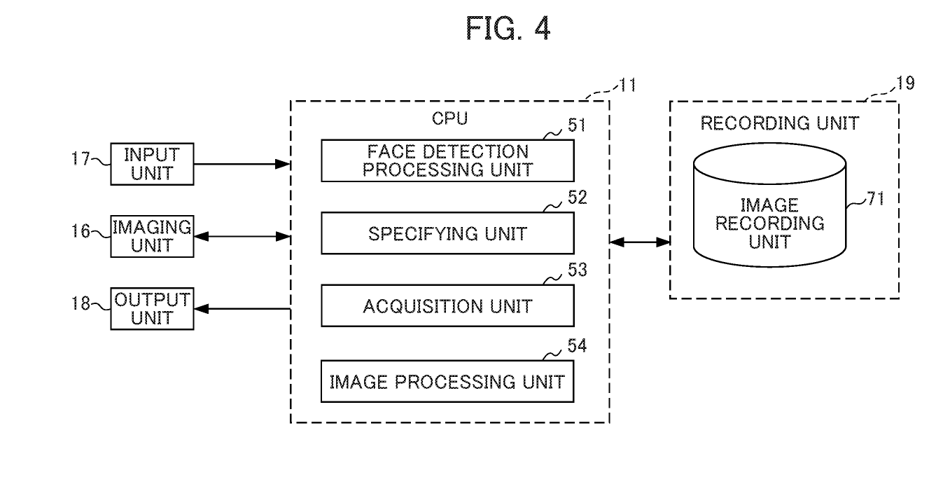

FIG. 4 is a functional block diagram illustrating a functional configuration for executing the makeup adjustment processing, in the functional configuration of the image capture apparatus 1 of FIG. 1.

The makeup adjustment processing is a set of pieces of processing for determining the makeup state of the subject, and of applying by adjusting the makeup processing of the image processing, according to the determined makeup state. In a case where the makeup adjustment processing is executed, as illustrated in FIG. 4, the a processor 11 achieves the functions of a face detection processing unit 51, a specifying unit 52, an acquisition unit 53, and an image processing unit 54. Furthermore, the makeup adjustment processing is executed, and then, the mode of the makeup processing (the non-makeup portion is set to a target/the makeup portion is set to the target/both of the portions are set to the target, the makeup effect is enhanced or reduced, the makeup effect is made use of/the makeup effect is changed, or the like) is set by the user.

In addition, an image storage unit 71 is set in one area of the storage unit 19. An imaged image acquired by a image capture unit 16 or data of an image acquired through a communication unit 20 or a drive 21 is recorded in the image storage unit 71.

The face detection processing unit 51 executes face detection processing. Specifically, the face detection processing unit 51 executes the face detection processing with respect to an image which is a processing target acquired by the image capture unit 16, or an image which is a processing target acquired from the image storage unit 71. Furthermore, in the following description, an example will be described in which the makeup adjustment processing is applied with respect to the image which is the processing target acquired by the image capture unit 16. As a result of executing the face detection processing, the number of detections of the face, and coordinates of various face parts such as coordinates of a face frame and eyes, coordinates of a nose, and coordinates of a mouth, in the image which is the processing target, are detected. Furthermore, the face detection processing can be realized by using a known technology, and thus, the detailed description will be omitted.

The specifying unit 52 extracts the contour of the face which is detected by the face detection processing unit 51. In addition, the specifying unit 52 prepares the skin map in the image of the face of which the contour is extracted. Further, the specifying unit 52 specifies the makeup portion (the face) and the non-makeup portion (the portion of the neck or the ears), on the basis of the contour of the face and the skin map. At this time, the specifying unit 52 specifies the area of the skin color inside of the contour of the face, in each position of the skin color configuring the face (for example, a portion of the forehead, under the eyes, the cheek, the nose, and the jaw, or the like), as the makeup portion (the face). In addition, the specifying unit 52 detects continuous skin color portions of an area greater than or equal to a predetermined threshold value, with respect to an outward direction from the contour of the face, as the non-makeup portion (the portion of the neck or the ears). At this time, the skin color to be used can be set to a fixed value recorded in advance (a predetermined color range). Furthermore, in the skin color portion which is detected with respect to the outward direction from the contour of the face, the neck and the ears are mainly a target, and thus, detection with respect to an upper direction of the contour (a direction of the head) may be omitted.

The acquisition unit 53 acquires the color information of the skin in the makeup portion (the face) and the non-makeup portion (a collar or the like close to the face) specified by the specifying unit 52. That is, the acquisition unit 53 acquires the color information of the skin in each of the positions of the skin color configuring the face (for example, the portion of the forehead, under the eyes, the cheek, the nose, the jaw, or the like), in the makeup portion of the subject (the face). At this time, the acquisition unit 53 acquires the skin color uniformity by acquiring a variation in the skin color (the dispersion situation) in the makeup portion of the subject (the face). Furthermore, an average value of the color information of the skin in each of the portions, or a value selected by using the color information of the skin in any portion as a representative value can be set as the color information of the skin in the entire “makeup portion”.

In addition, the acquisition unit 53 acquires the color information of the skin in the non-makeup portion of the subject (the portion of the neck or the ears). At this time, the acquisition unit 53 acquires the color information of the skin in the non-makeup portion of the subject (the portion of the neck or the ears) by suppressing an influence of a shaded portion (for example, a portion where the brightness of the color of the skin belongs to ⅓ of the dark side), in the portion specified as the non-makeup portion (the portion of the neck or the ears). The average value can be obtained by excluding the shaded portion, or the average value can be obtained by decreasing the weight of the shaded portion, as a method of suppressing the influence of the shaded portion in the portion specified as the non-makeup portion (the portion of the neck or the ears). Then, the acquisition unit 53 acquires a difference between the color information of the skin in the makeup portion of the subject (the face) and the color information of the skin in the non-makeup portion of the subject (the portion of the neck or the ears) (the skin color difference).

The image processing unit 54 executes the image processing of generating an image for displaying (reproducing, live view displaying, or the like) or recording (retaining or the like with respect to a storage medium) from the image which is a processing target. In the present embodiment, in a case where the face of the person is not included in the image which is a processing target, the image processing unit 54 generates image for displaying or recording by performing development processing with respect to the image which is a processing target. In addition, in a case where the face of the person is included in the image which is a processing target, the image processing unit 54 generates an image for a background and an image for makeup processing by performing the development processing with respect to the image which is a processing target. At this time, for example, color space conversion (conversion from a YUV color space to an RGB color space, or the like) is performed by using a conversion table which is different between the image for a background and the image for makeup processing. In the image for a background, a portion other than the skin color is mainly used as a background, and the image for makeup processing is mainly used for apply the makeup processing with respect to the skin color portion.

Further, the image processing unit 54 executes correction processing (the makeup processing) balanced between a color and a brightness with respect to the image for makeup processing, on the basis of the skin color difference, according to the mode setting by the user. For example, in a case where the makeup portion is set to be in a mode which is a target of the makeup processing, the image processing unit 54 executes the correction processing (the makeup processing) with respect to the makeup portion with an intensity based on the skin color uniformity. In addition, in a case where the non-makeup portion is set to be in a mode which is a target of the makeup processing, the image processing unit 54 executes correction processing (the makeup processing) with respect to the non-makeup portion, on the basis of the skin color difference and the skin color uniformity. Furthermore, in the correction processing (the makeup processing), specific processing of enhancing or reducing the makeup effect, of making use of the makeup effect, or of changing the makeup effect is selected according to the mode setting by the user. Then, the image processing unit 54 performs processing of blending the image for a background with the image for makeup processing, which is subjected to the makeup processing (for example, processing of performing an a blend by using a mask image in which the skin map value indicating the skin color likeness is set to an a value), and generates the image for displaying or recording.

Furthermore, here, the correction processing (the makeup processing) based on both of the skin color difference and the skin color uniformity is performed, but the correction processing only using one of the skin color difference and the skin color uniformity may be performed. For example, a tendency of the makeup effect of the subject (a change in the color or the brightness according to the makeup) is used by only using the skin color difference, and the intensity thereof is arbitrarily determined, and thus, the correction processing (the makeup processing) can be applied. In addition, the intensity of the makeup effect of the subject is used by only using the skin color uniformity, and various different makeup effects (for example, a makeup effect or the like prepared in advance) are selected, and thus, the correction processing (the makeup processing) can be applied. The selection of the correction processing (the makeup processing) using one of the skin color difference and the skin color uniformity or the correction processing (the makeup processing) using both of the skin color difference and the skin color uniformity can be changed according to the setting of the user.

### [Operation]

Next, an operation will be described.

### [Makeup Adjustment Processing]

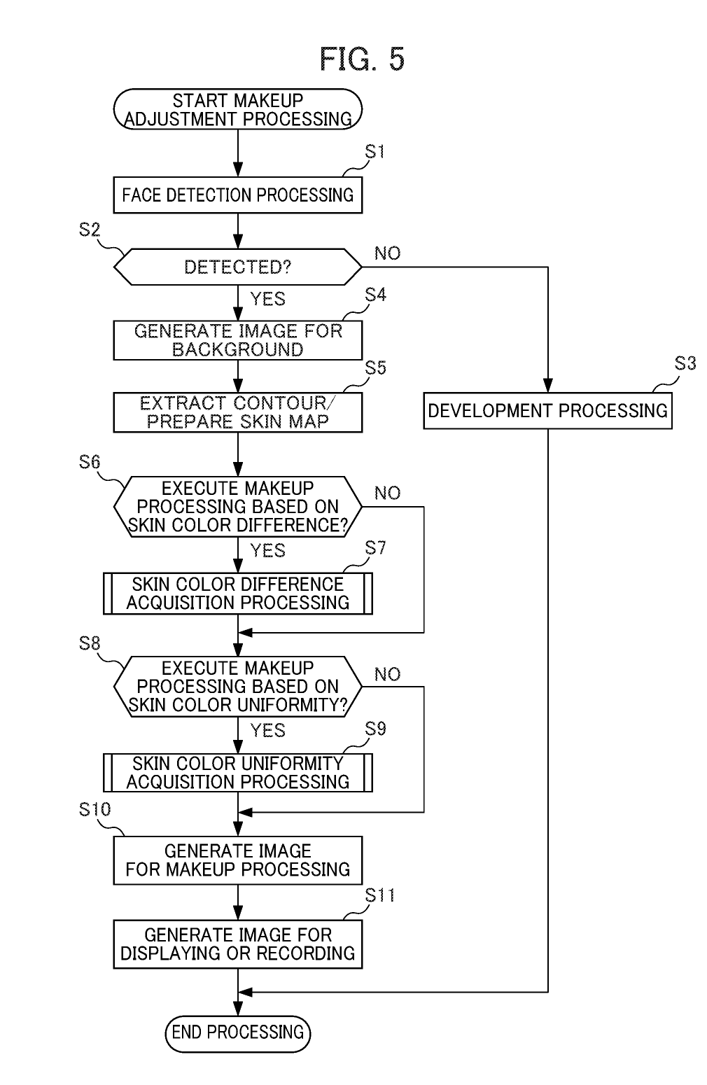

FIG. 5 is a flowchart illustrating a flow of the makeup adjustment processing executed by the image capture apparatus 1 of FIG. 1 having the functional configuration of FIG. 4. The makeup adjustment processing is started corresponding to the input of a manipulation of instructing the input unit 17 to execute the makeup adjustment processing by the user. For example, in a case where a mode of applying the makeup adjustment processing with respect to the imaged image is set by the user, the makeup adjustment processing is executed every the imaged image is acquired.

In Step S1, the face detection processing unit 51 executes the face detection processing with respect to the image which is a processing target. In Step S2, the image processing unit 54 determines whether or not the face is detected in the image which is a processing target. In a case where the face is not detected in the image which is a processing target, it is determined as NO in Step S2, and the processing proceeds to Step S3. On the other hand, in a case where the face is detected in the image which is a processing target, it is determined as YES in Step S2, and the processing proceeds to Step S4.

In Step S3, the image processing unit 54 performs the development processing with respect to the image which is a processing target, and generates the image for displaying or recording. In Step S4, the image processing unit 54 performs the development processing with respect to the image which is a processing target, and generates the image for a background. In Step S5, the specifying unit 52 extracts the contour of the face which is detected by the face detection processing unit 51, and prepares the skin map with respect to an image of the face of which the contour is extracted.

In Step S6, the acquisition unit 53 determines whether or not it is set that the makeup processing based on the skin color difference is applied. Furthermore, whether or not it is set so that the makeup processing based on the skin color difference is applied, can be determined on the basis of the previous mode setting of the user. In a case where it is not set so that the makeup processing based on the skin color difference is applied, it is determined as NO in Step S6, and the processing proceeds to Step S8. On the other hand, in a case where it is set so that the makeup processing based on the skin color difference is applied, it is determined as YES in Step S6, and the processing proceeds to Step S7.

In Step S7, skin color difference acquisition processing (described below) for acquiring the skin color difference is executed. In Step S8, the acquisition unit 53 determines whether or not it is set so that the makeup processing based on the skin color uniformity is applied. Furthermore, whether or not it is set so that the makeup processing based on the skin color uniformity is applied, can be determined on the basis of the previous mode setting of the user. In a case where it is not set so that the makeup processing based on the skin color uniformity is applied, it is determined as NO in Step S8, and the processing proceeds to Step S10. On the other hand, in a case where it is set so that the makeup processing based on the skin color uniformity is applied, it is determined as YES in Step S8, and the processing proceeds to Step S9.

In Step S9, skin color uniformity acquisition processing (described below) for acquiring the skin color uniformity is executed. In Step S10, the image processing unit 54 performs the development processing with respect to the image which is a processing target, and generates the image for makeup processing. At this time, the image processing unit 54 executes specific processing contents of enhancing or reducing a portion, which is a target of the makeup processing, and the makeup effect, or making use of the makeup effect, or of changing the makeup effect, on the basis of the previous mode setting of the user. In Step S11, the image processing unit 54 blends the image for a background with the image for makeup processing, and generates the image for displaying or recording. After Step S11, the makeup adjustment processing is ended.

### [Skin Color Difference Acquisition Processing]

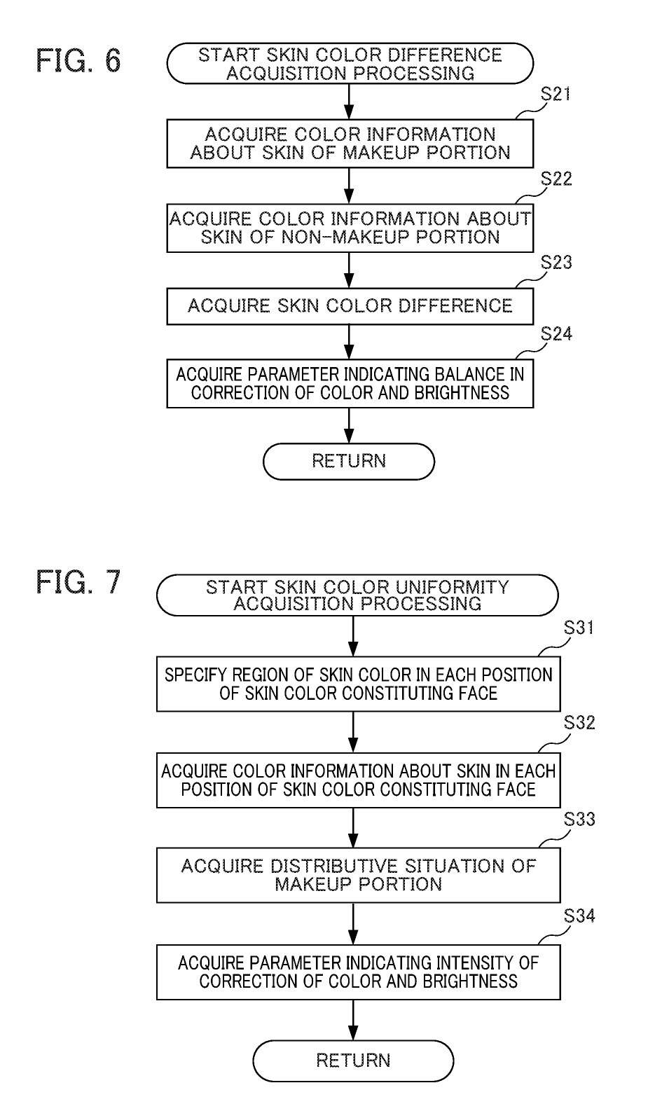

Next, a flow of the skin color difference acquisition processing, which is executed in Step S7 of the makeup adjustment processing, will be described. FIG. 6 is a flowchart illustrating the flow of the skin color difference acquisition processing. In Step S21, the acquisition unit 53 acquires the color information of the skin in the makeup portion of the subject (the face). Furthermore, the color information of the skin in the makeup portion of the subject (the face) can be set to the average value of the color information of the skin in each of the positions of the skin color configuring the face (for example, the portion of the forehead, under the eyes, the cheek, the nose, the jaw, or the like), or the value selected by using the color information of the skin in any portion as a representative value, in the makeup portion of the subject (the face). In Step S22, the acquisition unit 53 acquires the color information of the skin in the non-makeup portion of the subject (the portion of the neck or the ears). In Step S23, the acquisition unit 53 acquires a difference between the color information of the skin in the makeup portion of the subject (the face) and the color information of the skin in the non-makeup portion of the subject (the portion of the neck or the ears) (the skin color difference). In Step S24, the image processing unit 54 acquires a parameter indicating the balance in the correction of the color and the brightness with respect to the skin of the subject (the makeup tendency) at the time of applying the correction processing (the makeup processing) with respect to the image for makeup processing, on the basis of the skin color difference. After Step S24, the processing returns to the makeup adjustment processing.

### [Skin Color Uniformity Acquisition Processing]

Next, a flow of the skin color uniformity acquisition processing which is executed in Step S9 of the makeup adjustment processing will be described. FIG. 7 is a flowchart illustrating the flow of the skin color uniformity acquisition processing. In Step S31, the specifying unit 52 specifies the area of the skin color in each of the positions of the skin color configuring the face (for example, the portion of the forehead, under the eyes, the cheek, the nose, the jaw, or the like), inside of the contour of the face, as the makeup portion (the face). In Step S32, the acquisition unit 53 acquires the color information of the skin in each of the positions of the skin color configuring the face (for example, the portion of the forehead, under the eyes, the cheek, the nose, the jaw, or the like), in the makeup portion of the subject (the face). In Step S33, the acquisition unit 53 acquires a variation in the skin color in the makeup portion of the subject (the face) (the dispersion situation), and thus, acquires the skin color uniformity. In Step S34, the image processing unit 54 acquires a parameter indicating the intensity of the correction of the color and the brightness with respect to the skin of the subject (the makeup heaviness) at the time of applying the correction processing (the makeup processing) with respect to the image for makeup processing, on the basis of the skin color uniformity. After Step S34, the processing returns to the makeup adjustment processing.

According to such processing, the image capture apparatus 1 in the present embodiment calculates a difference between the color information of the makeup portion (the face) and the color information of the non-makeup portion (the portion of the neck or the ears) (the skin color difference), and, a variation in the skin color in each of the positions in the makeup portion (the face) (the skin color uniformity), in the skin area of the subject, and thus, determines the makeup state of the subject. Then, the image capture apparatus 1 applies the makeup processing with respect to the image which is a processing target, by adjusting the makeup processing of the image processing, according to the determined makeup state. At this time, the image capture apparatus 1 selects the processing contents that the non-makeup portion is set to a target/the makeup portion is set to a target/both of the portions are set to a target, the makeup effect is enhanced or reduced, the makeup effect is made use of/the makeup effect is changed, or the like, according to the setting of the user, and executes the makeup processing. Therefore, it is possible to adjust the makeup processing of the image processing, according to the makeup state of the subject.

### Modification Example 1

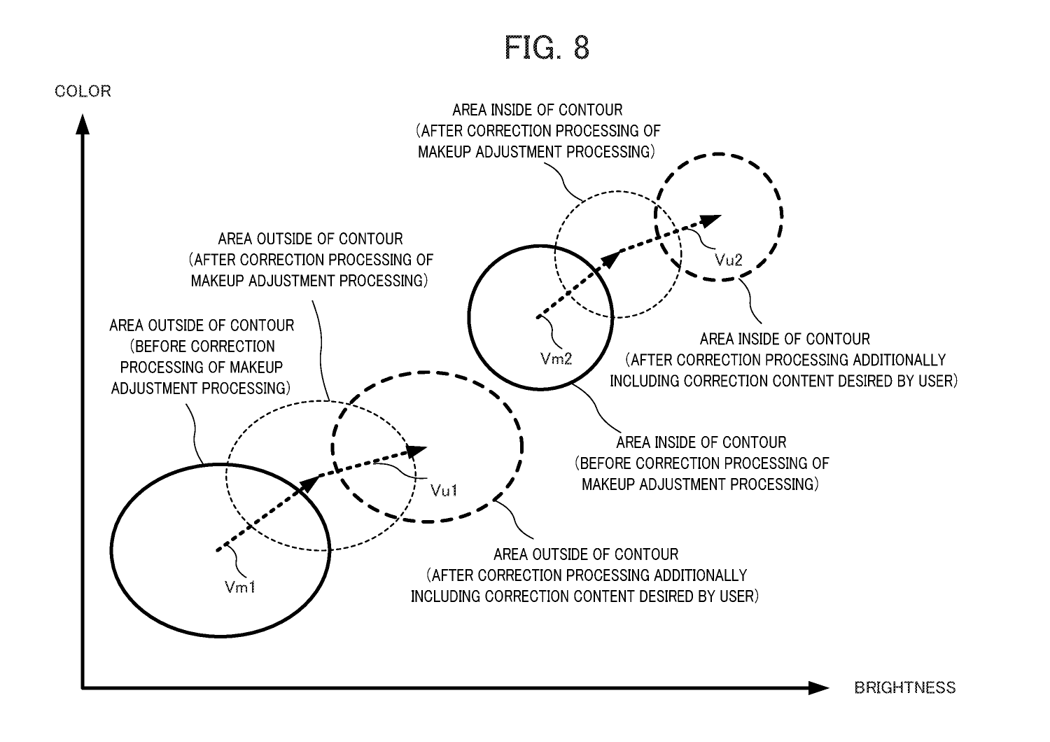

In the embodiment described above, the image, which is a processing target, may be subjected to the correction processing by adding correction contents desired by the user and an intensity thereof, in addition to the correction of the makeup adjustment processing of FIG. 5. In this case, the correction of the color and the brightness of the skin can be independently set, according to the desire of the user. FIG. 8 is a schematic view for illustrating the contents of the correction processing of adding the correction contents desired by the user and the intensity thereof, in addition to the correction of the makeup adjustment processing. As illustrated in FIG. 8, comprehensive correction can be performed with respect to the area outside of the contour in the skin color portion of the subject, by adding an additive correction vector Vu1 indicating the correction contents desired by the user in addition to the correction vector Vm1 indicating the correction of the makeup adjustment processing. Similarly, comprehensive correction can be performed with respect to the area inside of the contour in the skin color portion of the subject, by adding an additive correction vector Vu2 indicating the correction contents desired by the user in addition to the correction vector Vm2 indicating the correction of the makeup adjustment processing. According to such processing, it is possible to apply the makeup processing according to the preference of the user, while reflecting the makeup state of the subject.

The image capture apparatus 1 configured as described above includes the specifying unit 52, the acquisition unit 53, and the image processing unit 54. The specifying unit 52 specifies a first portion which is a skin color portion and does not have the makeup, in the person portion included in the image. The acquisition unit 53 acquires first skin color information corresponding to a skin color of the first portion which is specified by the specifying unit 52. The image processing unit 54 performs processing of adjusting the skin color in the person portion included in the image, on the basis of the first skin color information which is acquired by the acquisition unit 53. Accordingly, the skin color can be adjusted on the basis of the color information of the skin of the non-makeup portion of the person who is the subject, and thus, it is possible to suitably adjust the skin color, in consideration of the presence or absence of the makeup.

The specifying unit 52 further specifies a second portion which is a skin color and has the makeup, in the person portion included in the image. The acquisition unit 53 further acquires second information corresponding to a skin color of a second skin color portion which is specified by the specifying unit 52. The image processing unit 54 further adds second skin color information which is acquired by the acquisition unit 53, and performs processing of adjusting the skin color in the person portion included in the image. Accordingly, the skin color is adjusted by reflecting the makeup tendency of the person who is a subject, it is possible to suitably adjust the skin color, in consideration of the presence or absence of the makeup of the person who is a subject.

The image processing unit 54 adjusts an intensity of the processing of adjusting the skin color in the person portion included in the image, on the basis of a difference between the first skin color information and the second skin color information. Accordingly, it is possible to change an adjustment degree of the skin color in the face of the person who is a subject by reflecting a difference between the makeup portion and the non-makeup portion of the person who is a subject.

The image processing unit 54 performs processing of adjusting the skin color such that the skin color of the second portion is identical to the skin color of the first portion. Accordingly, it is possible to match the skin color of the non-makeup portion of the person who is a subject with the makeup portion.

The specifying unit 52 specifies the first portion in a position adjacent to the second portion, in the person portion included in the image. Accordingly, it is possible to suitably specify the makeup portion of the person who is a subject.

The acquisition unit 53 further acquires the dispersion situation of the second skin color information which is specified by the specifying unit 52. The image processing unit 54 further adds the dispersion situation of the second skin color information which is acquired by the acquisition unit 53, and performs the processing of adjusting the skin color in the person portion included in the image. Accordingly, it is possible to change the adjustment degree of the skin color, according to a variation in the skin color of the makeup portion of the person who is a subject.

The image processing unit 54 performs processing of adjusting the skin color in the first portion and the second portion. Accordingly, it is possible to adjust the skin color with a suitable adjustment degree, with respect to the makeup portion and the non-makeup portion of the subject.

The processing of adjusting the skin color includes first processing of adjusting the color of the skin and second processing of adjusting the brightness of the skin. The image processing unit 54 performs the processing of adjusting the skin color by independently setting each of an intensity of the adjustment of the first processing and an intensity of the adjustment of the second processing with respect with the face portion of the person included in the image, on the basis of the skin color information of the first portion. Accordingly, it is possible to adjust the skin color with a makeup effect different from the makeup tendency of the person who is a subject.

The first portion is a portion corresponding to the skin not having the makeup effect, in the person portion included in the image. Accordingly, it is possible to suitably adjust the skin color, according to the color of the skin of the subject.

In addition, the image capture apparatus 1 includes the specifying unit 52, the acquisition unit 53, and the image processing unit 54. The specifying unit 52 detects the contour of the face portion of the person included in the image. The acquisition unit 53 acquires the first skin color information from a portion adjacent to the outside of the contour which is detected by the specifying unit 52. The image processing unit 54 performs the processing adjusting the skin color in the person portion included in the image, on the basis of the first skin color information which is acquired by the acquisition unit 53. Accordingly, it is possible to adjust the skin color on the basis of the color information of the skin of the portion which is considered that the person who is a subject does not wear the makeup, and thus, it is possible to suitably adjust the skin color in consideration of the presence or absence of the makeup.

The acquisition unit 53 further acquires the second skin color information from the inside of the contour which is detected by the specifying unit 52. The image processing unit 54 further adds the second skin color information which is acquired by the acquisition unit 53, and performs the processing of adjusting the skin color in the person portion included in the image. Accordingly, it is possible to suitably adjust the skin color in consideration of the presence or absence of the makeup, on the basis of the color information of the skin of the portion which is considered that the person who is a subject does not wear the makeup and the color information of the skin of the portion which is considered that the person who is a subject wears the makeup.

In addition, the image capture apparatus 1 includes the specifying unit 52, the acquisition unit 53, and the image processing unit 54. The specifying unit 52 detects the skin color portion in the face portion of the person included in the image. The acquisition unit 53 acquires the dispersion situation of the skin color information of the skin color portion which is detected by the specifying unit 52. The image processing unit 54 performs the processing of adjusting the skin color in the face portion of the person included in the image, on the basis of the dispersion situation of the skin color information which is acquired by the acquisition unit 53. Accordingly, it is possible to change the adjustment degree of the skin color, according to a variation in the skin color in the makeup portion of the person who is a subject.

Furthermore, the present invention is not limited to the embodiments described above, and modifications, improvements, and the like within a range where the object of the present invention can be attained, are included in the present invention. For example, in the embodiments described above, the processing contents of whether or not to make use of the makeup effect/change the makeup effect may be selected from candidates including the makeup effect which is determined in the makeup adjustment processing and a plurality of makeup effects prepared in advance. For example, the user may select a desired makeup effect from any one of the makeup effects which is determined in the makeup adjustment processing, and, makeup effects of 6 patterns or 12 patterns, which are prepared in advance, and may apply the makeup processing. Further, the contents of the makeup processing may be determined according to the setting of the user, such that an intermediate makeup effect of the plurality of makeup effects is obtained.

In addition, the image processing unit 54 applies the common makeup processing with respect to the person portion included in the image by using the color information of the makeup portion and the color information of the non-makeup portion, but may apply the makeup processing such that the adjustment is different between the makeup portion and the non-makeup portion.

In addition, in the embodiments described above, the makeup processing is adjusted from a difference between the color information of the makeup portion and the color information of the non-makeup portion, but the makeup processing, which is adjusted on the basis of the color information of the non-makeup portion, may be applied only with respect to the non-makeup portion, without performing the makeup processing with respect to the makeup portion by maintaining the makeup performed by the user.

Although in the embodiment described above, a digital camera is adopted as an example for explaining the image capture apparatus 1 to which the present invention is applied, but the embodiment is not limited thereto. For example, the present invention can be applied to electronic devices in general that include a makeup processing function. For example, the present invention can be applied to a notebook type personal computer, a printer, a television receiver, a camcorder, a portable type navigation device, a cellular phone, a smartphone, a portable game device, and the like.

The processing sequence described above can be executed by hardware, and can also be executed by software. In other words, the hardware configuration of FIG. 7 is merely illustrative examples, and the present invention is not particularly limited thereto. More specifically, the types of functional blocks employed to realize the above-described functions are not particularly limited to the examples shown in FIG. 7, so long as the image capture apparatus 1 can be provided with the functions enabling the aforementioned processing sequence to be executed in its entirety. A single functional block may be constituted by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or storage medium to a computer or the like. The computer may be a computer equipped with dedicated hardware. In addition, the computer may be a computer capable of executing various functions, e.g., a general purpose personal computer, by installing various programs.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 1 in which the program is recorded, and a hard disk included in the storage unit 19 of FIG. 1, and the like.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image processing apparatus, comprising:
a processor which is an image processing processor that is configured to:
perform beautiful skin processing, which is processing of beautifying a skin color, on a person portion included in an image;
specify a first portion which is a skin color and is a non-makeup portion, and a second portion which is a skin color and a makeup portion, in the person portion of the image;
acquire first skin color information which is information corresponding to the skin color of the specified first portion, and second skin color information which is information corresponding to the skin color of the specified second portion; and
adjust the beautiful skin processing, on the basis of the acquired first skin color information and the acquired second skin color information.

2. The image processing apparatus according to claim 1,
wherein the image processing processor performs the beautiful skin processing upon adjusting an intensity thereof, on the basis of a difference between the first skin color information and the second skin color information.

3. The image processing apparatus according to claim 1,
wherein the processor performs the beautiful skin processing on the first portion and the second portion by adjusting the beautiful skin processing such that a direction of enhancing or reducing an effect is the same for each of the first portion and the second portion but an intensity thereof is different for each of the first portion and the second portion.

4. The image processing apparatus according to claim 1,
wherein the processor acquires a parameter indicating a makeup heaviness of the first portion for adjusting and performing the beautiful skin processing, on the basis of a difference between the first skin color information and the second skin color information.

5. The image processing apparatus according to claim 1,
wherein the processor adjusts and performs the beautiful skin processing such that a makeup effect of the second portion is enhanced or reduced.

6. The image processing apparatus according to claim 1,
wherein the processor adjusts and performs the beautiful skin processing so as to make use of a makeup effect of the second portion or changing the makeup effect of the second portion.

7. The image processing apparatus according to claim 1,
wherein the processor specifies a portion adjacent to the second portion in the person portion included in the image, as the first portion.

8. The image processing apparatus according to claim 1,
wherein the processor further acquires a dispersion situation of the specified second skin color information, and
further adjusts and performs the beautiful skin processing in view of the dispersion situation of the second skin color information acquired by the image processing.

9. The image processing apparatus according to claim 1,
wherein the beautiful skin processing includes first processing of adjusting a color of a skin, and second processing of adjusting a brightness of the skin, and
the processor adjusts and performs the beautiful skin processing by independently setting, on the basis of the first skin color information and the second skin color information, each of an intensity of the adjustment of the first processing and an intensity of the adjustment of the second processing for the person portion included in the image.

10. The image processing apparatus according to claim 1,
wherein the first portion is a portion corresponding to a skin, which is a portion not having a makeup effect, in the person portion included in the image.

11. An image processing apparatus, comprising:
a processor which is an image processing processor that is configured to:
detect a skin color portion in a face portion of a person included in an image;
acquire a dispersion situation of skin color information of the detected skin color portion; and
perform processing of adjusting a skin color in the face portion of the person included in the image, on the basis of the acquired dispersion situation of the skin color information.

12. An image processing method comprising:
an image processing of performing beautiful skin processing, which is processing of beautifying a skin color, on a person portion included in an image;
a specifying processing of specifying a first portion which is a skin color and is a non-makeup portion, and a second portion which is a skin color and is a makeup portion, in the person portion of the image; and
an acquisition processing of acquiring first skin color information which is information corresponding to the skin color of the first portion, and second skin color information which is information corresponding to the skin color of the second portion, specified by the specifying processing,
wherein in the image processing, the beautiful skin processing is adjusted on the basis of the first skin color information and the second skin color information acquired by the acquisition processing.

13. An image processing method comprising:
a detection processing of detecting a skin color portion in a face portion of a person included in an image;
an acquisition processing of acquiring a dispersion situation of skin color information of the skin color portion detected by the detection processing; and
an image correction processing of performing processing of adjusting a skin color in the face portion of the person included in the image, on the basis of the dispersion situation of the skin color information acquired by the acquisition processing.

14. A non-volatile storage medium recording a program causing a computer, which includes a processor and controls an image processing apparatus, to realize:
an image processing function of performing beautiful skin processing, which is processing of beautifying a skin color, on a person portion included in an image;
a specifying function of specifying a first portion which is a skin color and is a non-makeup portion, and a second portion which is a skin color and is a makeup portion, in the person portion of the image; and
an acquisition function of acquiring first skin color information which is information corresponding to the skin color of the first portion, and second skin color information which is information corresponding to the skin color of the second portion, specified by the specifying function,
wherein in the image processing function, the beautiful skin processing is adjusted on the basis of the first skin color information and the second skin color information acquired by the acquisition function.

15. A non-volatile storage medium recording a program causing a computer, which includes a processor and controls an image processing apparatus, to realize:
a detection function of detecting a skin color portion in a face portion of a person included in an image;
an acquisition function of acquiring a dispersion situation of skin color information of the skin color portion detected by the detection function; and
an image processing function of performing processing of adjusting a skin color in the face portion of the person included in the image, on the basis of the dispersion situation of the skin color information acquired by the acquisition function.
